(19) United States
(12) Patent Application Publication
(10) Pub. No.: US 2018/0144648 A1
(43) Pub. Date: May 24, 2018

(54) Positive Behavior Reinforcement Band

(71) Applicant: Naqvi Enterprises, LLC, Trumbull, CT (US)

(72) Inventor: Amanda Lynne Naqvi, Shelton, CT (US)

(73) Assignee: Naqvi Enterprises, LLC, Trumbull, CT (US)

(21) Appl. No.: 15/819,836

(22) Filed: Nov. 21, 2017

Related U.S. Application Data
(60) Provisional application No. 62/425,118, filed on Nov. 22, 2016.

(51) Int. Cl. G09B 1/14; G09B 19/00; A41D 20/00

(52) U.S. Cl. CPC G09B 1/14; A41D 20/00; G09B 19/00

(57) ABSTRACT

A wristband with removably affixed attachments. The wristband is fit to a minor's wrist, and attachments are affixed preferably according to the minor's behavior. The attachments may include aesthetic elements such as images and or colors, and may incorporate other elements such as scents or sparkles. The attachments may be uniform or vary in shape and size. Various retention devices may be employed to ensure minors are not able to detach and swallow the attachments. In certain embodiments, the wristband and attachments are employed in potty training.

### FIELD OF THE DISCLOSURE

The subject matter of the present disclosure generally relates to wrist ornamentation and more particularly to a band with readily attachable and detachable accessories.

### BACKGROUND OF THE DISCLOSURE

Parents often times struggle with getting their child to listen to and obey instructions. Particularly, it can be difficult to instill in children a self-awareness of their behavior and to promote good behavior. Punishing for bad behavior can be ineffective and can only be reactive to past behavior. Positive reinforcement can be productive, but parents and caretakers are often left to provide incentives on an ad hoc basis, which varies with time and may not be effective in promoting ongoing good behavior. Particularly, training young children to utilize a toilet effectively (commonly referred to as “potty training”) presents a challenge to many parents.

The subject matter of the present disclosure is directed to overcoming, or at least reducing the effects of, one or more of the problems set forth above.

### BRIEF SUMMARY OF THE DISCLOSURE

Disclosed is a wristband and accessories useful in reinforcing positive behavior in kids. The wrist band is accompanied by accessories that are attached thereto. For the purposes of this disclosure, the attached accessory may be referred to as a “Kudo” and the band itself referred to as a “Kudo Band.” Kudo bands provide a method to help children become better listeners through positive reinforcement. Parents become more aware of positive behavior, and in turn, provide positive reinforcement by using Kudos to incentivize children to behave better. Children naturally are drawn to positive reinforcement and better behavior often results, leaving parents at ease. Kudo Bands therefore promote a healthy family dynamic and the parent-child relationship is improved. Due to the design, Kudo accessories stay securely in place once attached. The construction of the accessory is designed in a way that is easily attached and detached from the bracelet. The material used is preferably non-abrasive and gentle.

### BRIEF DESCRIPTION OF THE DRAWINGS

FIG. 1 is a top perspective view of a wristband of a first embodiment.

FIG. 2 is a top perspective view of the wristband of the embodiment of FIG. 1 with attachments attached.

FIG. 3 is a front view of the wristband of the embodiment of FIG. 2.

FIG. 4 is a side view of the embodiment of FIG. 2.

FIG. 5 is a top plan view of the embodiment of FIG. 2.

FIG. 6 is a bottom plan view of the embodiment of FIG. 2.

FIG. 7 is a bottom perspective view of the embodiment of FIG. 2.

FIG. 8 is a top perspective view of one of the attachments shown in FIG. 1.

FIG. 9 is a bottom perspective view of the attachment of FIG. 8.

FIG. 10 is a top perspective view of a second embodiment;

FIG. 11 is a front view of the embodiment of FIG. 10;

FIG. 12 is a side view of the embodiment of FIG. 10;

FIG. 13 is a top plan view of the embodiment of FIG. 10;

FIG. 14 is a bottom plan view of the embodiment of FIG. 10;

FIG. 15 is a bottom perspective view of the embodiment of FIG. 10;

FIG. 16 is a top perspective view of the embodiment of FIG. 10 wherein the articles have been detached;

FIG. 17 is a top perspective view of one of the articles of the design of FIG. 10; and

FIG. 18 is a bottom perspective view of one of the articles of FIG. 10.

### DETAILED DESCRIPTION

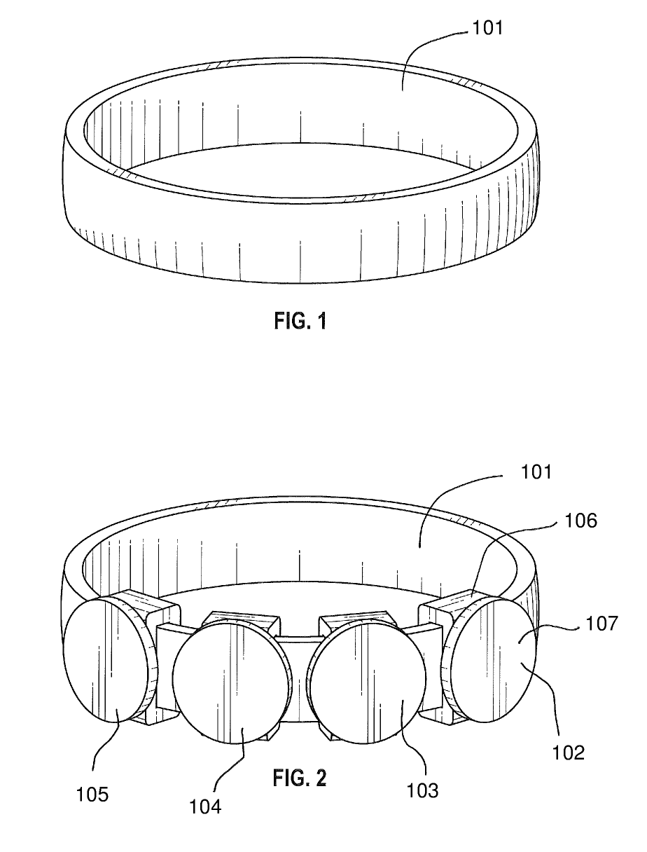

FIG. 1 is a top perspective view of Kudo Band 101 of an embodiment.

FIG. 2 is a front view of the Kudo Band of FIG. 1, with Kudos 102, 103, 104 and 105 attached. Each of the Kudos has a retention device 106 which serves to attach the Kudo to the Kudo Band. In the embodiment, the retention devices 106 are sufficiently flexible to allow removal upon the application of a particular amount of force, but to otherwise retain the Kudo on the Kudo Band in a particular disposition. Optionally, the amount of pressure required to remove the Kudo from the Kudo Band aids in preventing the Kudo from being removed by a minor, thereby increasing safety from accidental swallowing.

Various attachment means for retention of the Kudos may be employed including clipping, clamping, hook and loop, glue, snaps, buttons, hole/cufflink, bead, loop and clasp etc. Further, the Kudo may be presented as a digital image on a digital display, such as that of a smart-watch or electronic ink display. A Kudo Band will typically hold three to five kudos.

The Kudo Band may be formed from a suitable material such as silicone, rubber, plastic, paper or wood. The Kudos may be used as an incentive. A sticker chart referred to as a “Kudo Banz” chart may be used for a child's wrist. The chart may be maintained separate from the Kudo Band, may be integrated as a part thereof, or may be an attachment therefore. It may be used to help provoke positive behavior in children by encouraging positive behavior and reminding the children of their current “standings” via the chart. Generally, a complete set will consist of a Kudo Band and a plurality of accompanying Kudos. When a child exhibits good behavior, they are rewarded with a Kudo that is placed on their band.

In an embodiment, the Kudo band holds three to five Kudo, though this number is exemplary and any desirable number of Kudos could be employed. Further, the Kudos may be removed safely from a wristband at 5 lbs. pressure. In some embodiments, the pressure required to remove a Kudo assists in preventing the Kudo from being removed and swallowed by a minor. Alternatively or in addition, a securement feature may be incorporated into the Kudo so that it can only be removed by an adult or someone with a corresponding unlocking device.

In use, the Kudos can incentivize adults, employees, students. It can also be a reminder, not just an incentive, of good behavior and therefore promote self-consciousness.

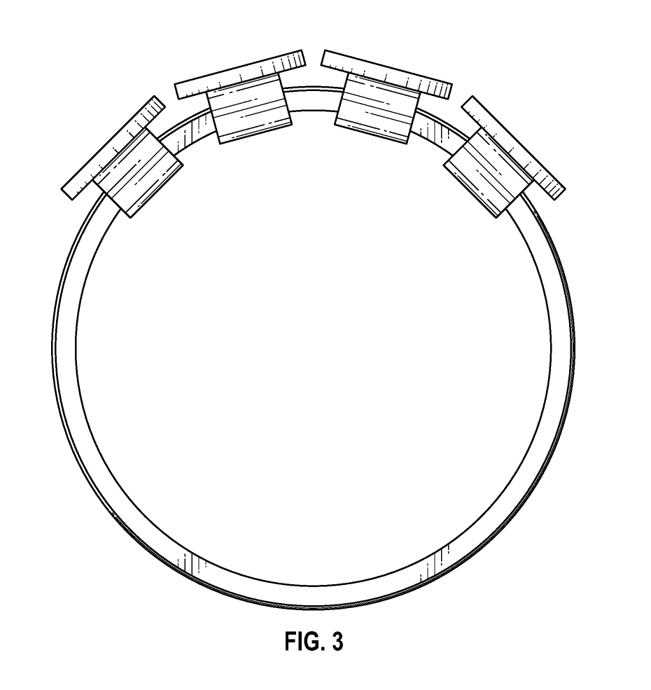

FIG. 3 is a front view of the Kudo Band and Kudos of FIG. 2.

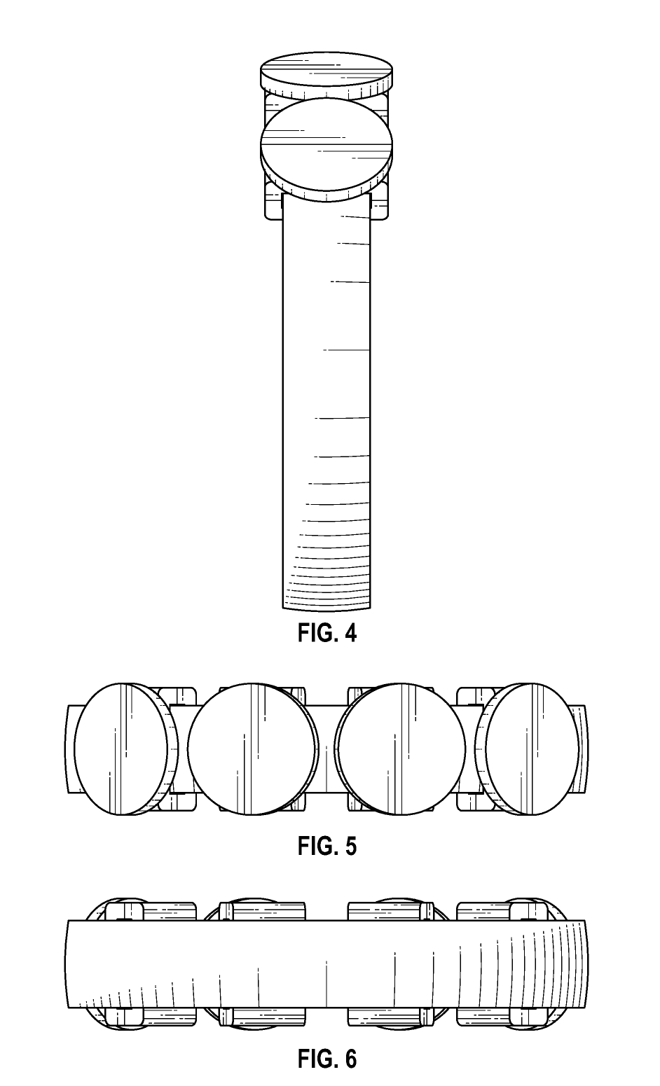

FIG. 4 is a side view of the Kudo Band and Kudos of FIG. 2.

FIG. 5 is a top plan view of the Kudo Band and Kudos of FIG. 2.

FIG. 6 is a bottom plan view of the Kudo Band and Kudos of FIG. 2.

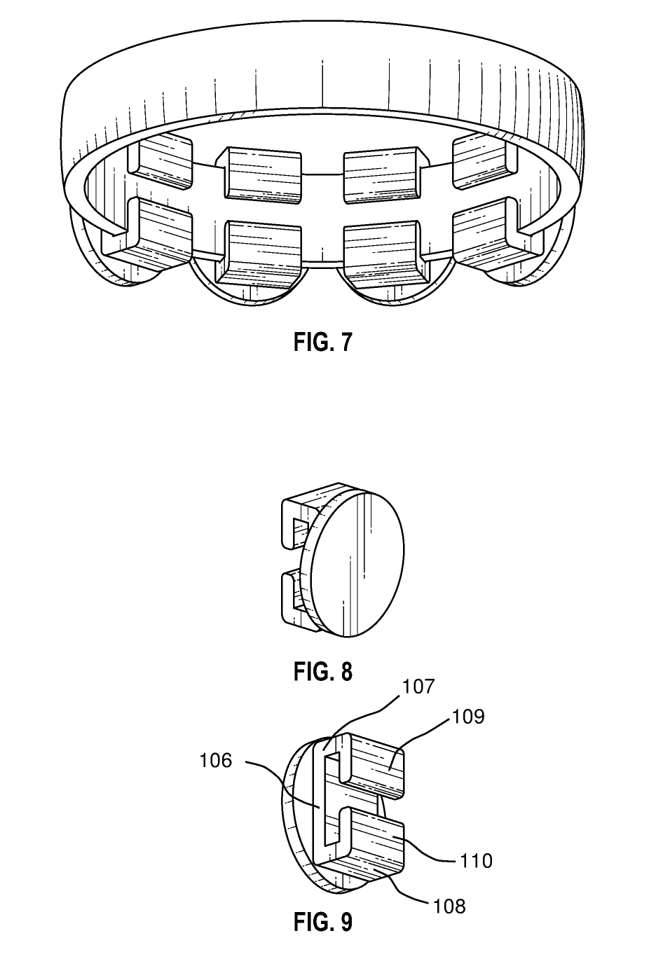

FIG. 7 is a bottom perspective view of the Kudo Band and Kudos of FIG. 2. In use, a child would don the Kudo Band and then Kudos would be added depending on the child's behavior. Preferably, the materials used to construct the both the Kudo Band and Kudos are non-toxic.

As can be seen in FIG. 9, in the embodiment retention device 106 has first and second U-shaped ends 107 and 108, respectively, having lips 109 and 110 respectively. To Install the Kudo to the Kudo Band, a first one of lips 109 and 110 are positioned around the Kudo Band (as viewed in FIG. 7), and the other is then clipped on. Optionally, the retention device, Kudo Band, or both may have an elastic property that facilitates the securement of the retention device in place.

FIG. 8 is a bottom perspective view of one of the Kudos shown in FIG. 1. While the Kudo is generally circular in the embodiment, other shapes including, without limitation, stars, ovals, circles, polygons, etc. may be added. Kudos may vary also in color and may incorporate such features as images, texturing, scents and additives such as sparkles. In this manner, children may receive specific Kudos for specific behaviors or as a spontaneous reward for good behavior. In some embodiments, the Kudo is shaped in the outline of an animal or character and includes an imagine thereof.

In one embodiment, an Kudo Band sans any Kudos is provided to a child being potty trained. In response to the child successfully and correctly employing a toilet, the child is awarded with a Kudo, which is affixed to the Kudo Band.

FIG. 9 is a bottom perspective view of one of the Kudos of the design of FIG. 2.

FIG. 10 is a top perspective view of a second embodiment Kudo Band and attached Kudos wherein the Kudo band has a wavy design.

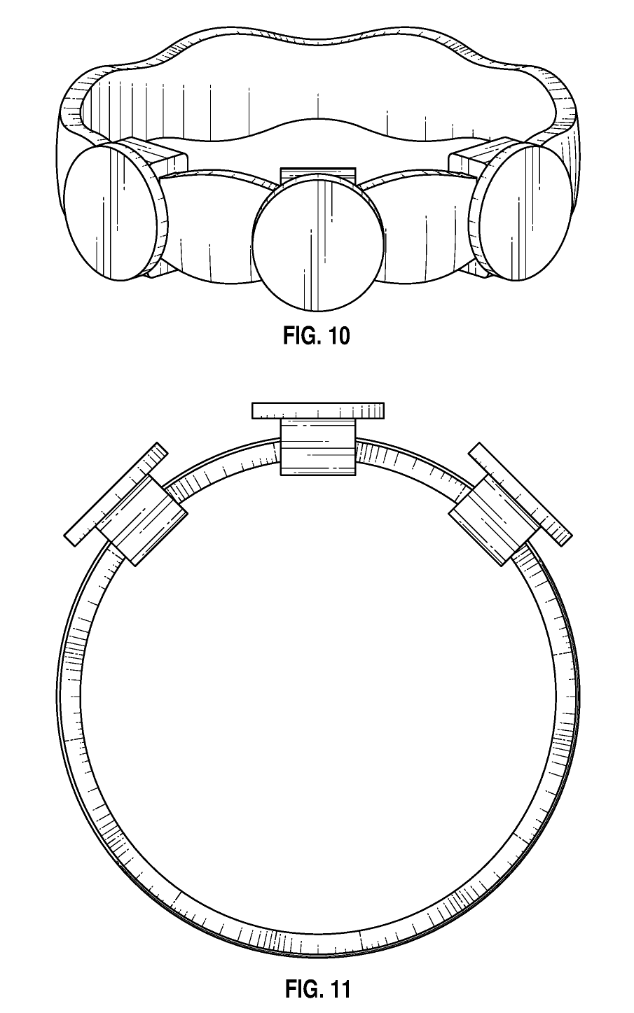

FIG. 11 is a front view of the Kudo Band and Kudos of FIG. 10.

FIG. 12 is a side view of the Kudo Band and Kudos of FIG. 10.

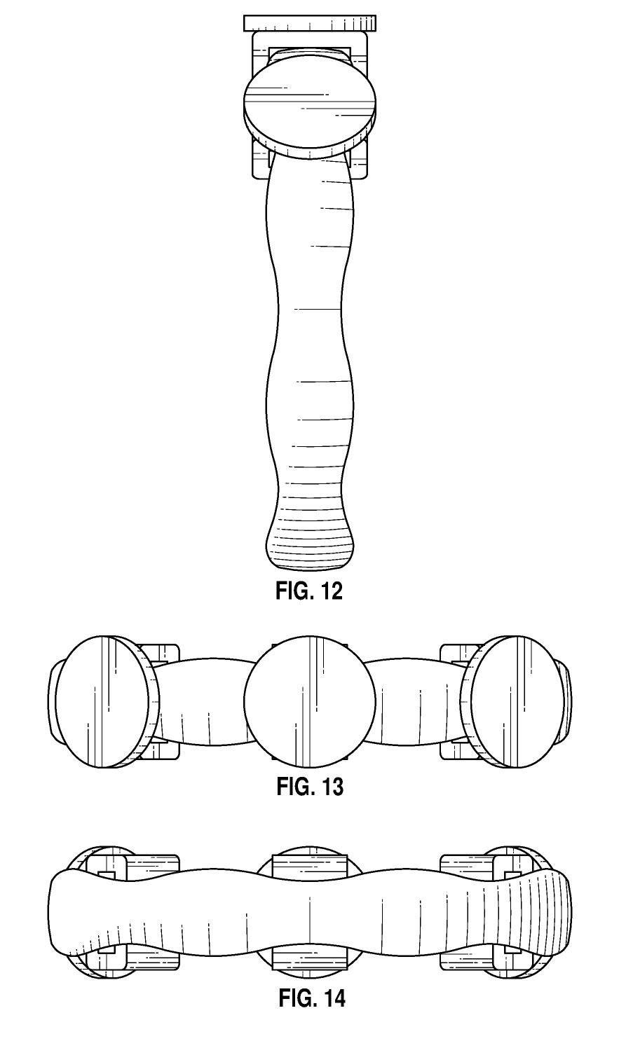

FIG. 13 is a top plan view of the Kudo Band and Kudos of FIG. 10.

FIG. 14 is a bottom plan view of the Kudo Band and Kudos of FIG. 10.

FIG. 15 is a bottom perspective view of the Kudo Band and Kudos of FIG. 10.

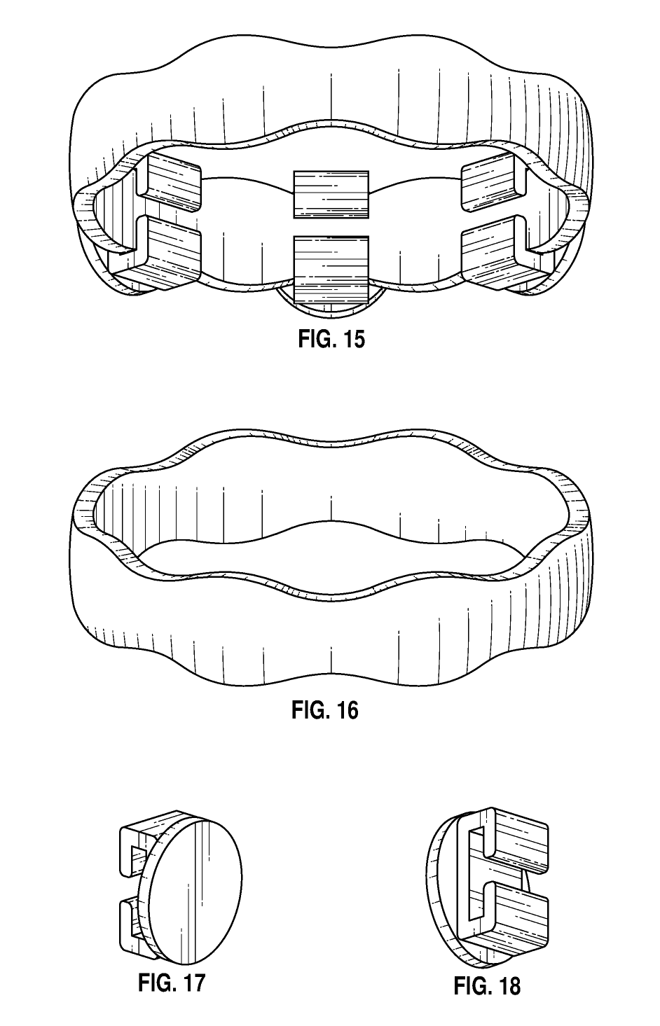

FIG. 16 is a top perspective view of the Kudo Band of FIG. 10 wherein the Kudos have been detached.

FIG. 17 is a top perspective view of one of the Kudos of FIG. 10.

FIG. 18 is a bottom perspective view of one of the Kudos of FIG. 10.

The terms “bottom”, “below”, “top” and “above” as used herein do not necessarily indicate that a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. An apparatus for tracking and encouraging good behavior in children, comprising:
a wrist band configured to fit around the wrist of a minor and maintain a relative orientation with respect to the minor's arm; and
a plurality of attachments removably affixed to the wrist band, wherein each attachment is representative of an acknowledgment of behavior.

2. The apparatus of claim 1 wherein at least one of the attachments is removably affixed to the wrist band by an element selected from the group consisting of clipping, clamping, hook and loop, glue, snaps, buttons, hole/cufflink, bead, and loop and clasp.

3. The apparatus of claim 2 wherein the attachment is removably affixed by clipping including a first and second U-shaped member, each having a lip for affixing against the inside of the wrist band.

4. The apparatus of claim 3, wherein each attachment is a rounded shape.

5. The apparatus of claim 3 wherein the wrist band is formed from one of the materials selected from the group consisting of silicone, rubber, plastic, paper and wood.

6. The apparatus of claim 3 wherein the shape of at least one of the attachments is selected from the group consisting of one of a rounded rectangle, an oval, a polygon and a star.

7. The apparatus of claim 3 wherein at least one of the attachments has one of the elements selected from the group consisting of an image, texturing, scent and an additive.

8. The apparatus of claim 3 wherein the attachment has an electronic display configured to display an image.

9. The apparatus of claim 8 wherein the electronic display is of a display type selected from the group consisting of a liquid crystal display (LCD), light-emitting diode (LED) display, organic light emitting diode (OLED) display and an electronic ink display.

10. A method for tracking and encouraging good behavior in children, comprising:
providing a wrist band configured to fit around the wrist of a minor and maintain a relative orientation with respect to the minor's arm;
providing a plurality of attachments; and
removably affixing each of the plurality of attachments to the wrist band as an acknowledgment of behavior in response to an action by the minor.

11. The method of claim 10 wherein at least one of the attachments is removably affixed to the wrist band by an element selected from the group consisting of clipping, clamping, hook and loop, glue, snaps, buttons, hole/cufflink, bead, and loop and clasp.

12. The method of claim 11 wherein the attachment is removably affixed by clipping including a first and second U-shaped member, each U-shaped member having a lip for affixing against the inside of the wrist band.

13. The method of claim 12, wherein each attachment is a rounded shape.

14. The method of claim 12 wherein the wrist band is formed from a material selected from the group consisting of silicone, rubber, plastic, paper and wood.

15. The method of claim 12 wherein the shape of at least one of the attachments is selected from the group consisting of a rounded rectangle, an oval, a polygon and a star.

16. The method of claim 12 wherein at least one of the attachments has one of the elements selected from the group consisting of an image, texturing, scent and an additive.

17. The method of claim 12 wherein the attachment has an electronic display configured to display an image.

18. The method of claim 17 wherein the electronic display is of a display type selected from the group consisting of liquid crystal display (LCD), light-emitting diode (LED) display, organic light emitting diode (OLED) display and an electronic ink display.

19. A wristband attachment system, comprising:
a closed-ring shaped wristband configured to fit around the wrist of a minor and being elastic whereby it may be donned on a user's wrist;
a plurality of removably attached attachments;
each attachment having a display area including a first surface and a second parallel surface separated by an edge; and
each attachment having a retention device comprised of two U-shaped elements each with a lip configured to be disposed against an inside of the wristband when the attachment is attached to the wrist band.

20. The wristband of claim 19 wherein a width of the wristband has alternating areas of narrower and wider width.
